(19) United States
(12) Patent Application Publication
(10) Pub. No.: US 2008/0192967 A1
(43) Pub. Date: Aug. 14, 2008

(54) Circuit arrangement with bonded SMD component

(76) Inventors: Chor Fan Chan, Singapore (SG); Meng Kiang Lim, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/012,752

(22) Filed: Feb. 5, 2008

(30) Foreign Application Priority Data
Feb. 6, 2007 (DE) 10 2007 005 862.6

(51) Int. Cl. H04R 25/00; H01R 9/00

(52) U.S. Cl. 381/312; 361/776

(57) ABSTRACT

The invention is to increase the degree of miniaturization, in particular of amplifier circuit boards of hearing aids. An SMD component and an electronic component of a circuit arrangement are to be electrically connected to each other by a wire bond connection. The circuit arrangement comprises a printed circuit board and an integrated circuit mounted on the printed circuit board. One or more further integrated circuits are disposed between the said integrated circuit and the printed circuit board. An SMD component is mounted directly on the integrated circuit. Alternatively, the SMD component is mounted directly on the printed circuit board and electrically connected to one of a stack of integrated circuits. The SMD component is electrically connected to the integrated circuit by means of bond wires. Space can be saved on the printed circuit board as a result of the stack wise arrangement.

### CROSS REFERENCE TO RELATED APPLICATIONS

This application claims priority of German application No. 10 2007 005 862.6 filed Feb. 6, 2007, which is incorporated by reference herein in its entirety.

### FIELD OF THE INVENTION

The present invention relates to a circuit arrangement, in particular for a hearing device, having an SMD component and a further electronic component. In the present context a hearing device is understood to mean in particular a hearing aid, but can also refer to a headset, earphones and the like.

### BACKGROUND OF THE INVENTION

Hearing aids are wearable hearing devices that are designed to provide hearing assistance to the hearing-impaired. In order to accommodate the numerous individual requirements, different designs of hearing aids are provided, such as behind-the-ear (BTE) hearing aids and in-the-ear (ITE) hearing aids, e.g. including concha hearing aids or completely-in-the-canal (CIC) hearing aids. The hearing aids cited by way of example are worn on the outer ear or in the auditory canal. In addition, however, bone conduction hearing aids and implantable or vibrotactile hearing aids are also available on the market. With said devices, the damaged hearing is stimulated either mechanically or electrically.

The main components of hearing aids essentially include an input transducer, an amplifier and an output transducer. The input transducer is generally a receiving transducer, e.g. a microphone, and/or an electromagnetic receiver, e.g. an induction coil. The output transducer is mostly implemented as an electroacoustic converter, e.g. a miniature loudspeaker, or as an electromechanical converter, e.g. a bone conduction receiver. The amplifier is typically integrated into a signal processing unit. This basic layout is shown in FIG. 1 using the example of a behind-the-ear hearing aid. One or more microphones 2 for recording ambient sound are integrated into a hearing aid housing 1 that is designed to be worn behind the ear. A signal processing unit 3, which is also integrated into the hearing aid housing 1, processes the microphone signals and amplifies them. The output signal from the signal processing unit 3 is transmitted to a loudspeaker and/or receiver 4, which outputs an acoustic signal. The sound is optionally transmitted to the ear drum of the hearing aid wearer via a sound tube which is fixed in the auditory canal by means of an otoplastic. The power supply of the hearing aid and in particular that of the signal processing unit 3 is provided by a battery 5 which is likewise integrated into the hearing aid housing 1.

The principal objective in the continuing development of hearing aids and other hearing devices is their miniaturization. This applies in particular also to the signal processing unit, which is typically mounted on a printed circuit board (PCB substrate). Conversely, a further aim is to integrate more and more functions into a hearing aid, with the result that the space requirement therein increases. In order to avoid having to increase the size of a hearing aid, however, the circuit arrangement must be designed proportionally more compactly.

In order to enable more components to be accommodated on a hearing aid circuit board, it was always necessary in the prior art to increase the size of the surface area of the board accordingly. An improvement in the compactness of the circuit board that was in many cases assembled from integrated circuits and SMD components was not achieved thereby.

An arrangement consisting of a substrate, a semiconductor component disposed thereon and a lead frame mounted in turn thereon is known from the patent specification U.S. Pat. No. 6,472,737 B1. The semiconductor component is connected both to the substrate and to the lead frame by way of bond wires.

The publication DE 40 17 217 A1 also describes an electronic component having a lead frame, a semiconductor chip and a flat capacitor. The flat capacitor is provided with a connecting contact area on both its upper face and its lower face. Furthermore, the capacitor is mounted with its lower face in an electrically conductive connection on the lead frame, and the semiconductor chip is disposed in an electrically conductive connection on the upper face of the capacitor. An electrically conductive adhesive establishes an electrical connection between the semiconductor chip and the capacitor. Bond wires are used for the purpose of electrically contacting the lead frame to the capacitor and the semiconductor chip.

Furthermore, the European patent specification EP 0 575 051 B1 discloses stacked multi-chip modules consisting of semiconductor dice and an interconnect medium which is supported by a mounting surface of a carrier component. The interconnect medium is a connecting substrate which is stacked on a surface of the semiconductor die. The components are electrically connected to one another by means of a wire bonding technique.

Also known from the publication US 2002/0076076 A1 is a condenser microphone assembly. An integrated circuit (IC) or an application-specific integrated circuit (ASIC) can be provided under the base of the microphone assembly.

### SUMMARY OF THE INVENTION

The object of the present invention is to improve the compactness of a circuit board and in particular a hearing aid circuit board.

This object is achieved according to the invention by means of a circuit arrangement, in particular for a hearing device, having an SMD component and a further electronic component, wherein the SMD component and the electronic component are electrically interconnected by means of a wire bond connection. In this context the term “electronic component” is understood to refer to any active or passive component, such as a printed circuit board, substrate, SMD component, integrated circuit, etc.

Thus, it is advantageously possible to mount SMD components onto virtually any substrates and to realize the electrical contacting thereof in a very compact manner. Moreover, SMD components can be used which generally have smaller dimensions than other comparable components.

Preferably the circuit arrangement has a carrier and, as the further electronic component, a second integrated circuit which is mounted on the carrier, the SMD component being mounted on the second integrated circuit and electrically connected to the second integrated circuit by means of bond wires. A suitable carrier may include, for example, a printed circuit board (PCB), an LTCC substrate and the like.

Alternatively, the circuit arrangement may be equipped with a carrier and a first integrated circuit, mounted directly on the carrier, as well as a second integrated circuit, mounted on the first integrated circuit, and the SMD component, mounted directly on the carrier, the SMD component being electrically connected to the second integrated circuit by means of bond wires.

Space can advantageously be saved by stacking the SMD component or the second integrated circuit onto the first integrated circuit on the printed circuit board or, as the case may be, the carrier. In this way a higher level of miniaturization can be achieved. Moreover, it is particularly advantageous if the first or second integrated circuit is connected directly to the SMD component via bond wires. This makes the connections shorter and in addition the connections can be laid directly.

In a special embodiment, the SMD component can be mounted onto the second integrated circuit or the carrier, with at least one further integrated circuit being inserted at the same time. A correspondingly large amount of space on the carrier can be saved as a result of this multiple stacking.

Equally, at least a third integrated circuit can be mounted between the first integrated circuit and the second integrated circuit. Obviously this also leads to a saving of space on an amplifier or hearing aid circuit board at least in the lateral direction.

The integrated circuits may be application-specific integrated circuits (ASICs). With ASICs specifically there is namely the problem that their degree of integration is not as high as in the case of standard ICs.

The first integrated circuit can be mounted on the carrier using flip-chip, CSP, BGA or wire bonding technology. This means that the principle of stacking integrated circuits and/or SMD components with one another and interconnecting them via bond wires can be applied to all possible types of integrated circuits.

The SMD component can include for example a piezoelectric crystal. In this case there is the further advantage that the oscillations of the piezoelectric crystal are not transmitted directly via the printed circuit board to another oscillation-sensitive component when the SMD crystal is mounted on another component. No direct transmission of the oscillations takes place even when the SMD crystal is mounted on the carrier and an oscillation-sensitive component is mounted on an integrated circuit.

According to another embodiment, the SMD component is electrically connected by means of one of the bond wires to a bond pad on the carrier and from there by means of another of the bond wires to the second integrated circuit. This can be advantageous when space conditions are very restricted on the second integrated circuit or the SMD component.

As has already been indicated above, a circuit arrangement according to the invention can be used particularly advantageously in a hearing aid. In this case it is possible on the one hand to exploit the increased degree of miniaturization and on the other hand to benefit from a reduction in oscillation transmission as a result of the stacking technology and wire-bonding interconnect technology.

### BRIEF DESCRIPTION OF THE DRAWINGS

The present invention is explained in more detail below with reference to the accompanying drawings, in which:

FIG. 1 shows the basic layout of a hearing aid according to the prior art;

FIG. 2 shows an arrangement of circuit elements according to a first embodiment of the present invention;

FIG. 3 shows an arrangement of circuit elements according to a second embodiment of the present invention;

FIG. 4 shows a side view of an arrangement of circuit elements according to a third embodiment of the present invention; and

FIG. 5 shows a plan view of the circuit arrangement according to FIG. 4.

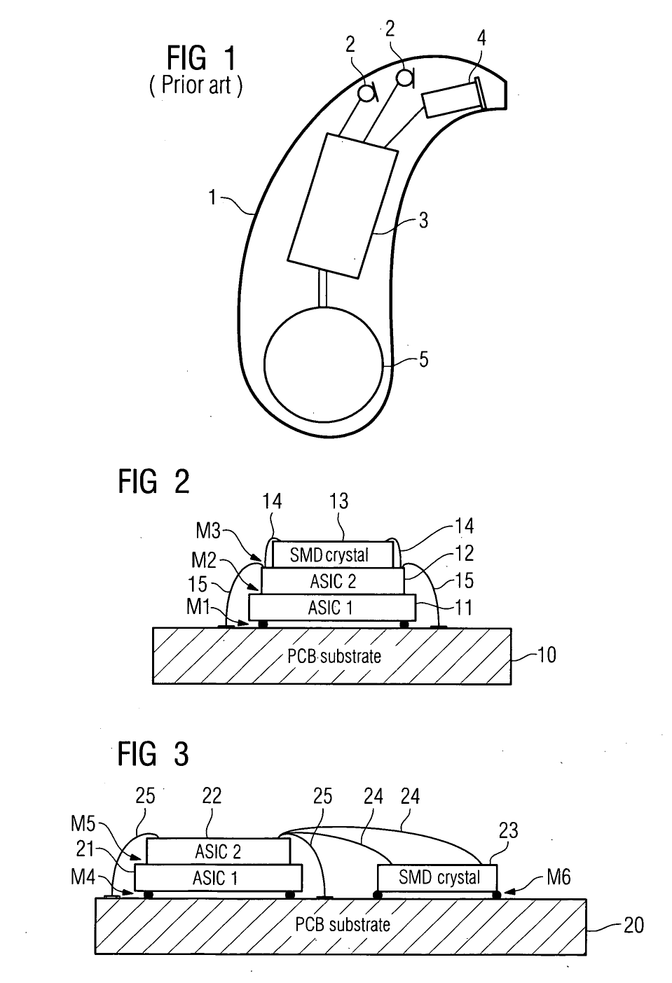

### DETAILED DESCRIPTION OF THE INVENTION

The exemplary embodiments described in more detail below represent preferred embodiments of the present invention.

The circuit arrangement shown by way of example in FIG. 2 consists of a printed circuit board or PCB substrate 10 as carrier, onto which a first ASIC 11 is mounted. This can be realized using any chip assembly technology such as, for example, flip-chip technology, wire-bonding technology, CSP (Chip Scale Package) technology, BGA (Ball Grid Array) technology, etc. In FIG. 2, the first assembly step for electrically and/or mechanically connecting the first ASIC 11 to the PCB substrate is labeled M1. A second ASIC 12 is mounted onto the first ASIC 11, again using any desired assembly technology. The second assembly step is labeled M2 in FIG. 2.

An SMD crystal 13 which is based on the piezoelectric principle and provides an oscillation frequency or clock frequency is mounted directly onto the second ASIC 12. The SMD crystal 13 is attached to the second ASIC 12 in turn in accordance with any of the aforementioned bonding techniques (gluing, soldering, etc.). The bonding step is labeled M3 in FIG. 2.

In the example shown in FIG. 2, the electrical connection between the SMD crystal 13 and the second ASIC 12 is accomplished with the aid of bond wires 14. The second ASIC 12 is for its part connected to the PCB substrate 10 via bond wires 15. Other electrical connections of the illustrated components can, of course, also be realized by means of bond wires. A combination with other contacting and connection techniques is at the discretion of the individual.

The layout depicted in FIG. 2 has the following advantages:

1. A higher degree of miniaturization can be achieved by stacking the ASIC and SMD components.
2. Stacking the ASIC and SMD components one on top of the other enables more effective use of a circuit layout in the vertical direction.
3. The wire bonding technique permits a short and direct connection between, for example, an ASIC and an SMD component.
4. The first ASIC 11 can be mounted on the PCB substrate 10 using any assembly technologies, such as flip-chip, wire bonding, CSP, BGA, etc.
5. Any types of multi-layer substrates can be used as the printed circuit board: e.g. multi-layer PCB substrates, multi-layer thick-film substrates, multi-layer LTCC (Low Temperature Co-fired Ceramic) substrates, multi-layer LTCC substrates with countersunk bonding space (cavity).
6. As a result of the vertical stacking, the oscillations of the SMD crystal 13 are not transmitted directly via the PCB substrate 10, but at most are transmitted attenuated by the intermediate components and the connecting materials such as adhesive, metal or solder. This enables a better attenuation to be achieved particularly for the emission of higher frequencies. The oscillation transmission or structure-borne sound transmission via the bond wires is practically irrelevant.

FIG. 3 shows a further exemplary embodiment of a circuit arrangement according to the invention. In this example a first ASIC 21 is mounted on the PCB substrate 20. This takes place by means of an assembly step M4 which can be carried out in the same way as step M1 according to the example shown in FIG. 2.

A second ASIC 22 is adhesively bonded, soldered or attached by some other means onto the first ASIC 21. This attachment step is labeled M5 in FIG. 3 and can be carried out in the same way as step M2 in the example shown in FIG. 2.

An SMD crystal 23 is also soldered or attached by some other means onto the PCB substrate 20. The attachment step is labeled M6 in FIG. 3.

The SMD crystal 23 is wired to the second ASIC 22 by means of bond wires 24, analogously to the example shown in FIG. 2. The second ASIC 22 is for its part electrically contacted to the PCB substrate 20 by means of bond wires 25. Here too, the wiring is merely indicated symbolically and can also be implemented differently between the individual electronic elements. All that is essential is that bond wire connections 24 exist between the multi-chip module, consisting of the ASICs 21 and 22, and the SMD component 23.

The exemplary embodiment according to FIG. 3 has in turn the following advantages, in particular for a hearing aid amplifier:

1. The bond wires enable a short and direct connection from an ASIC to the SMD component.
2. The first ASIC 21 can be mounted on the PCB substrate 20 using any assembly technology, such as flip-chip, wire bonding, CSP, BGA, etc.
3. All the aforementioned multi-layer substrates can be used.

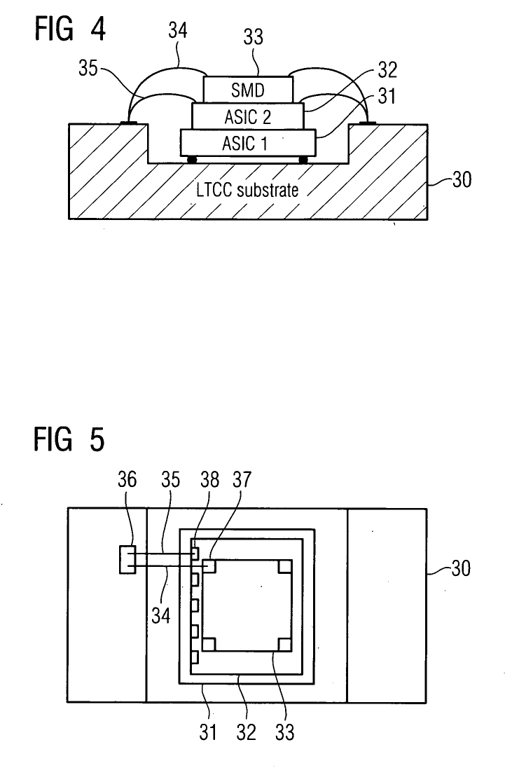

FIG. 4 shows a third exemplary embodiment of a circuit arrangement according to the invention in a side view or in cross-section. A first ASIC 31 is introduced into the cavity of an LTCC substrate 30. Disposed thereon, as in the exemplary embodiment shown in FIG. 2, is a second ASIC 32 and on the latter in turn the SMD component 33. The arrangement is shown in a plan view in FIG. 5. In this case, however, the SMD component 33 is not, as in the example shown in FIG. 2, bonded directly to the second ASIC 32. Instead, the bonding connection between the SMD component 33 and the second integrated circuit or second ASIC 32 is implemented indirectly via a bond pad 36 on the carrier or LTCC substrate 30. In concrete terms, the SMD component 33 has a contact 37 which is connected to the bond pad 36 on the LTCC substrate 30 by means of the bond wire 34. There is also a bond wire connection from the bond pad 36 to a bond contact 38 of the second ASIC 32 by means of the bond wire 35.

1.-10. (canceled)

11. A circuit arrangement, comprising:
an electronic component; and
an SMD component that are electrically interconnected with the electronic component by a bond wire connection.

12. The circuit arrangement as claimed in claim 11, further comprising a carrier.

13. The circuit arrangement as claimed in claim 12, wherein the carrier is a printed circuit board or a LTCC substrate.

14. The circuit arrangement as claimed in claim 12, wherein the electronic component is an integrated circuit and mounted on the carrier.

15. The circuit arrangement as claimed in claim 14, wherein the SMD component is mounted on the integrated circuit and electrically connected to the integrated circuit by a bond wire.

16. The circuit arrangement as claimed in claim 15, wherein at least a further integrated circuit is mounted between the integrated circuit and the carrier.

17. The circuit arrangement as claimed in claim 16, wherein the further integrated circuit is mounted the carrier using a method selected from the group consisting of: flip-chip, CSP, BGA, and wire bonding technology.

18. The circuit arrangement as claimed in claim 14, wherein a further integrated circuit is directly mounted on the carrier.

19. The circuit arrangement as claimed in claim 18, wherein the further integrated circuit is mounted on the carrier using a method selected from the group consisting of: flip-chip, CSP, BGA, and wire bonding technology.

20. The circuit arrangement as claimed in claim 18, wherein the integrated circuit is mounted on the further integrated circuit.

21. The circuit arrangement as claimed in claim 20, wherein the SMD component is directly mounted on the carrier and electrically connected to the integrated circuit by a bond wire.

22. The circuit arrangement as claimed in claim 21, wherein at least a third integrated circuit is mounted between the integrated circuit and the further integrated circuit.

23. The circuit arrangement as claimed in claim 12, wherein the SMD component is electrically connected to a bond pad on the carrier by a bond wire and electrically connected to the electronic component from the bond pad by another bond wire.

24. The circuit arrangement as claimed in claim 11, wherein the electronic component is an ASIC.

25. The circuit arrangement as claimed in claim 11, wherein the SMD component comprises a piezoelectric crystal.

26. The circuit arrangement as claimed in claim 11, wherein the circuit arrangement is used in a hearing device.

27. A hearing aid, comprising:
a circuit arrangement, wherein the circuit arrangement comprises:
an electronic component that is mounted on the carrier, and
an SMD component that are electrically interconnected with the electronic component by a bond wire connection.
